(19) United States
(12) Patent Application Publication
(10) Pub. No.: US 2022/0207326 A1
(43) Pub. Date: Jun. 30, 2022

(54) ANOMALY DETECTION, DATA PREDICTION, AND GENERATION OF HUMAN-INTERPRETABLE EXPLANATIONS OF ANOMALIES

(71) Applicant: Intuit Inc., Mountain View, CA (US)

(72) Inventor: Nazanin Zaker Habibabadi, Sunnyvale, CA (US)

(73) Assignee: Intuit Inc., Mountain View, CA (US)

(21) Appl. No.: 17/139,869

(22) Filed: Dec. 31, 2020

(51) Int. Cl. G06N 3/04; H04L 12/26; G06N 3/08; G06K 9/62

(52) U.S. Cl. CPC G06N 3/0445; G06K 9/6298; G06N 3/08; H04L 43/067

(57) ABSTRACT

This disclosure relates to identifying anomalies in, predicting data points for, and determining a feature's importance to input time series data and outputs from the data. An example system is configured to perform operations including obtaining, by an autoencoder, time series data including multiple sequences of data points, encoding, by an encoder of the autoencoder, the obtained time series data into encoded data, decoding, by a decoder of the autoencoder, the encoded data into decoded data, reconstructing time series data from the decoded data, determining a reconstruction error based on the reconstructed time series data and the obtained time series data, identifying an anomaly based on the reconstruction error. The system is also configured to predict one or more data points from the encoded data and determine a contribution (SHAP value) of a feature to the obtained time series data that is associated with a plurality of features.

### TECHNICAL FIELD

This disclosure relates generally to detecting anomalies in multivariate time series data, predicting future time series data based on past historical patterns, and generating human-interpretable explanation of such anomalies and predictions.

### DESCRIPTION OF RELATED ART

Attempts to determine relationships between a large number of features in multivariate time series data and resulting outcomes are used to assist in modeling black box systems. In one example, companies attempt to model and predict future cash flow and revenue based on known inputs, such as payments from specific customers, payments to specific vendors, and other time series historical data. A company may wish to predict future cash flow and revenue, and the company may wish to be alerted to any anomalies in the input data that may impact such cash flow and revenue. As the number of features and input data increases, attempting to model relationships and outcomes becomes increasingly more difficult. In particular for multivariate anomaly detection, it becomes increasingly difficult to determine instances in which anomalous activity occurs in the input data that substantially affects cash flow, revenue, or other output metrics of interest to a user.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable features disclosed herein.

One innovative aspect of the subject matter described in this disclosure can be implemented as a method for identifying anomalies for the last data point of each the input time series. In the small to mid-market industries, it is very important for them to check how their company is performing in the last month and make immediate actions in respect to that. As a consequence, this anomaly detection method, focuses only on last time stamps. An example method includes obtaining, by an autoencoder, time series data including multiple sequences of data points, encoding, by an encoder of the autoencoder, the obtained time series data into encoded data, decoding, by a decoder of the autoencoder, the encoded data into decoded data, reconstructing time series data from the decoded data, determining a reconstruction error based on the reconstructed time series data and the obtained time series data, and identifying an anomaly based on the reconstruction error.

In some exemplary implementations, the method includes determining a Shapley additive explanation (SHAP) value for one or more features associated with the obtained time series data and the output of the autoencoder. A SHAP value indicates a contribution of a feature to the output. For example, the method includes generating a two dimensional tensor including differences between a last group of data points of the obtained time series data and a last group of corresponding data points of the reconstructed time series data. The method also includes determining, from the two dimensional tensor, a SHAP value for one or more features associated with an output of the autoencoder (or a prediction model), wherein the obtained time series data is associated with a plurality of features. In generating the SHAP values, the method is capable of generating two SHAP values per feature: a first SHAP value associated with non-anomalous outputs of the autoencoder and a second SHAP value associated with the anomalous outputs of the autoencoder. The first SHAP value may be a mean of the absolute values (MAV) of SHAP values determined for each output of the autoencoder when not identified as anomalous (in other words, non-anomalous outputs), and the second SHAP value may be a MAV of SHAP values determine for each output of the autoencoder when identified as anomalous.

The method is also capable of predicting one or more data points from the encoded data. Predicting the one or more data points includes obtaining the encoded data generated by the encoder of the autoencoder and decoding, by a decoder of a prediction model, the encoded data to generate prediction data including the one or more predicted data points.

Another innovative aspect of the subject matter described in this disclosure can be implemented in a system to identify anomalies. In some implementations, the system includes one or more processors and a memory coupled to the one or more processors. The memory can store instructions that, when executed by the one or more processors, cause the system to perform operations including obtaining, by an autoencoder, time series data including multiple sequences of data points, encoding, by an encoder of the autoencoder, the obtained time series data into encoded data, decoding, by a decoder of the autoencoder, the encoded data into decoded data, reconstructing time series data from the decoded data, determining a reconstruction error based on the reconstructed time series data and the obtained time series data, and identifying an anomaly based on the reconstruction error.

In some exemplary implementations, the operations include determining a SHAP value for one or more features associated with the obtained time series data and the output of the autoencoder. For example, the operations include generating a two dimensional tensor including differences between a last group of data points of the obtained time series data and a last group of corresponding data points of the reconstructed time series data. The operations also include determining, from the two dimensional tensor, a SHAP value for one or more features associated with an output of the autoencoder (or a prediction model), wherein the obtained time series data is associated with a plurality of features. In generating the SHAP values, the method is capable of generating two SHAP values per feature: a first SHAP value associated with non-anomalous outputs of the autoencoder and a second SHAP value associated with the anomalous outputs of the autoencoder. The first SHAP value may be a MAV of SHAP values determined for each output of the autoencoder when not identified as anomalous (in other words, non-anomalous outputs), and the second SHAP value may be a MAV of SHAP values determine for each output of the autoencoder when identified as anomalous.

The operations may also include predicting one or more data points from the encoded data. Predicting the one or more data points includes obtaining the encoded data generated by the encoder of the autoencoder and decoding, by a decoder of a prediction model, the encoded data to generate prediction data including the one or more predicted data points.

Another innovative aspect of the subject matter described in this disclosure can be implemented in a non-transitory, computer readable medium storing instructions that, when executed by one or more processors of a system to identify anomalies, cause the system to perform operations including obtaining, by an autoencoder, time series data including multiple sequences of data points, encoding, by an encoder of the autoencoder, the obtained time series data into encoded data, decoding, by a decoder of the autoencoder, the encoded data into decoded data, reconstructing time series data from the decoded data, determining a reconstruction error based on the reconstructed time series data and the obtained time series data, and identifying an anomaly based on the reconstruction error.

In some exemplary implementations, the operations include determining a SHAP value for one or more features associated with the obtained time series data and the output of the autoencoder. For example, the operations include generating a two dimensional tensor including differences between a last group of data points of the obtained time series data and a last group of corresponding data points of the reconstructed time series data. The operations also include determining, from the two dimensional tensor, a SHAP value for one or more features associated with an output of the autoencoder (or a prediction model), wherein the obtained time series data is associated with a plurality of features. In generating the SHAP values, the method is capable of generating two SHAP values per feature: a first SHAP value associated with non-anomalous outputs of the autoencoder and a second SHAP value associated with the anomalous outputs of the autoencoder. The first SHAP value may be a MAV of SHAP values determined for each output of the autoencoder when not identified as anomalous (in other words, non-anomalous outputs), and the second SHAP value may be a MAV of SHAP values determine for each output of the autoencoder when identified as anomalous.

The operations may also include predicting one or more data points from the encoded data. Predicting the one or more data points includes obtaining the encoded data generated by the encoder of the autoencoder and decoding, by a decoder of a prediction model, the encoded data to generate prediction data including the one or more predicted data points.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a block diagram of a system to identify anomalies and predict data, according to some implementations.

FIG. 2 shows a block diagram of an example autoencoder.

FIG. 3 shows a block diagram of the example autoencoder in FIG. 2, according to some implementations.

FIG. 4 shows an illustrative flowchart depicting an example operation for identifying anomalies using an autoencoder, according to some implementations.

FIG. 5 shows a block diagram of an example prediction model for predicting output data points, according to some implementations.

FIG. 6 shows an illustrative flowchart depicting an example operation for predicting output data points using a prediction model, according to some implementations.

FIG. 7 shows an illustrative flowchart depicting an example operation for determining a Shapley additive explanation (SHAP) value for a feature, according to some implementations.

FIG. 8 shows a block diagram of an autoencoder for interfacing with a feature identifier to generate SHAP values, according to some implementations.

FIG. 9 shows a depiction of an example indication of SHAP values for different features, according to some implementations.

Like reference numbers and designations in the various drawings indicate like elements.

### DETAILED DESCRIPTION

The following description is directed to certain implementations of identifying anomalies in multivariate input data, predicting output data from the input data, and determining a contribution of a feature in the input data towards the anomalies or output data. However, a person having ordinary skill in the art will readily recognize that the teachings herein can be applied in a multitude of different ways. It may be readily understood that certain aspects of the disclosed systems and methods can be arranged and combined in a wide variety of different configurations, all of which are contemplated herein.

Typical anomaly detection systems use parametric regressions to attempt to identify anomalies in input data. Such regressions may be used to determine an anomaly of a specific feature in time series data including multiple time sequences for different features, but the specific feature may not have a significant impact on the output data. For example, payments from one client may appear to be anomalous because of a one-time purchase, but the client or purchase may not be of a significant enough amount to affect business revenue or cash flow. In addition, each time sequence may be within a threshold (and not appear anomalous), but together may cause an anomaly in the output (such as to cause a significant change in cash flow or revenue). Rules and associations may be manually generated in an ad hoc manner to attempt to cover such instances, but such rules and associations do not account for all contributions to anomalies. In addition, as the number of features and their associated data sequences increase as inputs, it becomes impossible to manually or in a supervised manner determine all rules and associations to properly model the effect of inputs on the output. Furthermore, some domain knowledge or ground truths is required for supervised analysis, and data may appear random that determining such knowledge is impossible.

For unsupervised analysis, clustering methods (such as to determine local outliers) do not capture relationships between variables, specific temporal aspects in the data, and so on if the data is not compactly distributed or along a defined distribution. In addition, increasing the dimensions to a large number for input data makes clustering impossible with current resources. As a result, pseudorandom data or data not following a defined distribution and with a high number of dimensions becomes difficult to impossible to cluster in a useful amount of time.

As such, there is a need for unsupervised multivariate time series analysis that is able to capture both temporal relationships and relationships between features to detect anomalies.

Typical future prediction systems are designed separate from an anomaly detection system. In this manner, results from the two systems may not be synergistic. For example, a future prediction system may predict a drop in revenue that may appear anomalous, but the anomaly detection system may not indicate that an anomaly is to occur. As a result, conflicting information may be presented to a user or inaccuracies from not incorporating the two systems may cause incorrect information to be presented to a user for managing a business. There is a need for combining unsupervised multivariate time series analysis with a future prediction system into one system.

In addition, determining which features or drivers of an anomaly is important for a user to understand a detected anomaly or a predicted output. For example, if the system identifies which vendors, clients, or business departments may drive a predicted drop or increase in revenue, the user may take actions directed towards those identified groups. However, in previous anomaly detection systems, detecting an anomaly is difficult as the number of features and data sequences increases, much less attempting to indicate which features contribute to the anomaly. There is a need for determining the contribution of each feature to an output (especially during a detected anomaly).

In some implementations, a system can identify anomalies in multivariate input data that may impact output data. For example, a system is configured to identify instances in time series data that impact output data, which may include cash flow, revenue, or other performance metrics of a business. The system includes one or more recurrent neural networks (such as an autoencoder) to identify an anomaly. In identifying the anomaly, the system obtains time series data, with the time series data including multiple sequences of data points. Each sequence of data points includes measurements for a feature over time (such as amount paid to a vendor over a time period, amount received from a client over a time period, amount due to a vendor, amount due from a client, revenue of a client, amount received by a business department, amount paid by a business department, and so on). Each data point of a sequence corresponds to another data in the other sequences based on time (such as data points of different sequences being sampled at the same time or over the same time period).

The system encodes the obtained data using a trained encoder to generate a code, decodes the code using a trained decoder to generate a reconstructed time series data, and determines a reconstruction error by comparing the obtained time series data to the reconstructed time series data. The reconstruction error is based on a difference between the obtained time series data and the reconstructed time series data. The system identifies an anomaly in the obtained time series data based on the reconstruction error.

In some implementations, the system is also configured to predict one or more data points from the obtained data. The system includes a second trained decoder for decoding the code. The system may thus reconstruct time series data including one or more predicted data points from the decoded data.

In some implementations, the system is further configured to determine a contribution of a feature towards an output (such as a detected anomaly). The system applies a SHAP operation to the encoded data from the autoencoder, and the system determines a SHAP value for a feature associated with the time series data used to generate the encoded data.

In this manner, the system is configured to indicate anomalies in the input data that may significantly affect the output data, predict output data, and identify a feature's effect on the output data. The system provides such information to a user so that a user may understand the effects of current business features and attempt to efficiently manage such effects if desired.

Various aspects of the present disclosure provide a unique computing solution to a unique computing problem that did not exist. More specifically, the problem of identifying anomalies, predicting outputs, and determining contributions to the anomalies associated with a business did not exist prior to the accumulation of vast numbers of financial or other electronic commerce-related transaction records, and is therefore a problem rooted in and created by technological advances in businesses to accurately differentiate anomalies in business operation and determine measures to counteract such anomalies.

As the number of transactions and records increases, the ability to identify certain instances of anomalies, determine future operations of the business (such as cash flow or revenue), determine drivers of the anomalies affecting the business, and thus being able to determine a plan of action requires the computational power of modern processors and machine learning models to accurately identify such risks, in real-time, so that appropriate action can be taken to reduce or eliminate such risks. Therefore, implementations of the subject matter disclosed herein are not an abstract idea such as organizing human activity or a mental process that can be performed in the human mind, for example, because it is not practical, if even possible, for a human mind to evaluate the transactions of thousands to millions, or more, at the same time to identify anomalies and predict business output.

In the following description, numerous specific details are set forth such as examples of specific components, circuits, and processes to provide a thorough understanding of the present disclosure. The term “coupled” as used herein means connected directly to or connected through one or more intervening components or circuits. The terms “processing system” and “processing device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

In the figures, a single block may be described as performing a function or functions. However, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example input devices may include components other than those shown, including well-known components such as a processor, memory, and the like.

Several aspects of anomaly detection, data prediction, and feature identification for a business will now be presented with reference to various apparatus and methods. These apparatus and methods will be described in the following detailed description and illustrated in the accompanying drawings by various blocks, components, circuits, devices, processes, algorithms, and the like (collectively referred to herein as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

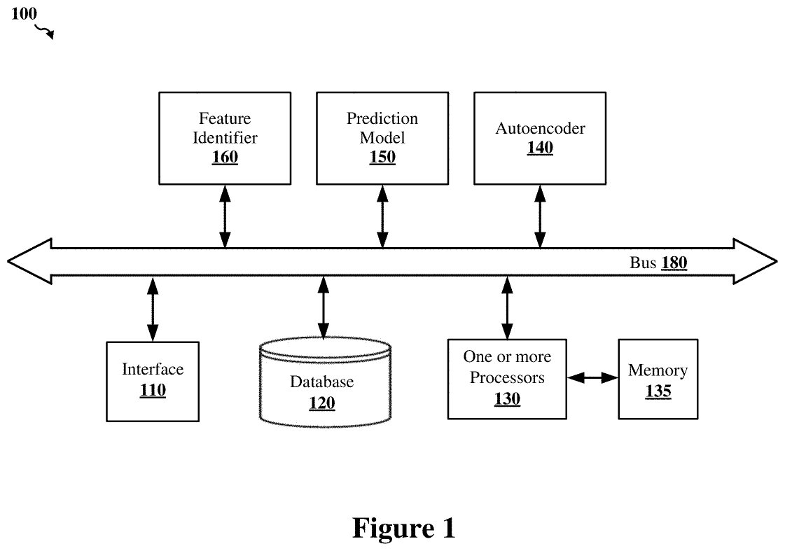

FIG. 1 shows a block diagram of a system 100 to identify anomalies and predict data, according to some implementations. Although described herein as identifying anomalies and predicting data with respect to revenue, cash flow, and other business metrics, in some other implementations, the system 100 can detect anomalies and predict data in other scenarios including time series data, such as predicting real estate or asset prices, identifying potential product supply issues, and so on. The system 100 is shown to include an input/output (I/O) interface 110, a database 120, one or more processors 130, a memory 135 coupled to the one or more processors 130, an autoencoder 140, a prediction model 150, a feature identifier 160, and a data bus 180. The various components of the system 100 may be connected to one another by the data bus 180, as depicted in the example of FIG. 1. In other implementations, the various components of the system 100 may be connected to one another using other suitable signal routing resources.

The interface 110 may include any suitable devices or components to obtain information (such as input data) to the system 100 and/or to provide information (such as output data) from the system 100. In some instances, the interface 110 includes at least a display and an input device (such as a mouse and keyboard) that allows users to interface with the system 100 in a convenient manner. The input data includes time series data, and the time series data includes multiple sequences of data points measured over time. For example, each sequence may include daily, weekly, monthly, or other suitable intervals of measurements for a feature of the time series data. As used herein, a feature is an input that may be a possible driver of an output of interest to the user. For example, if the user is interested in revenue or cash flow of a business, example features include a vendor, a client, a business department, or another entity (such as a revenue service for tax payments or insurance company for insurance payments), and sequences associated with the features may include payments to and from another business (such as vendors and clients), outstanding invoices to and from another business, periodic costs (such as property taxes, insurance, payroll, and so on), and so on. In this manner, each sequence may be associated with a specific financial metric, and each feature may correspond to one or more sequences. Features may be at the business level, a business department level (such as services versus software departments), or at any other level of granularity that may be measured. In a specific example, a first feature may be a first vendor, a second feature may be a second vendor, and so on, a third feature may be a first client, a fourth feature may be a second client, and so on, a fifth feature may be a first business department, a sixth feature may be a second business department, and so on as desired by the user. Features may be overlapping or mutually exclusive in terms of granularity (such as being associated with different sequences or with the same sequences). For example, payments to a department including payments from a client may be a sequence associated with a first feature associated with the department and a second feature associated with the client.

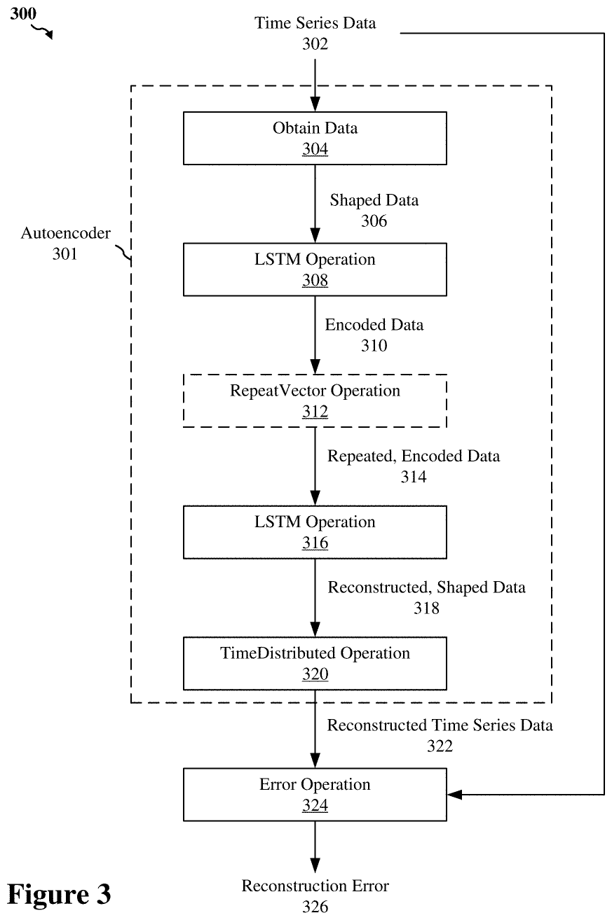

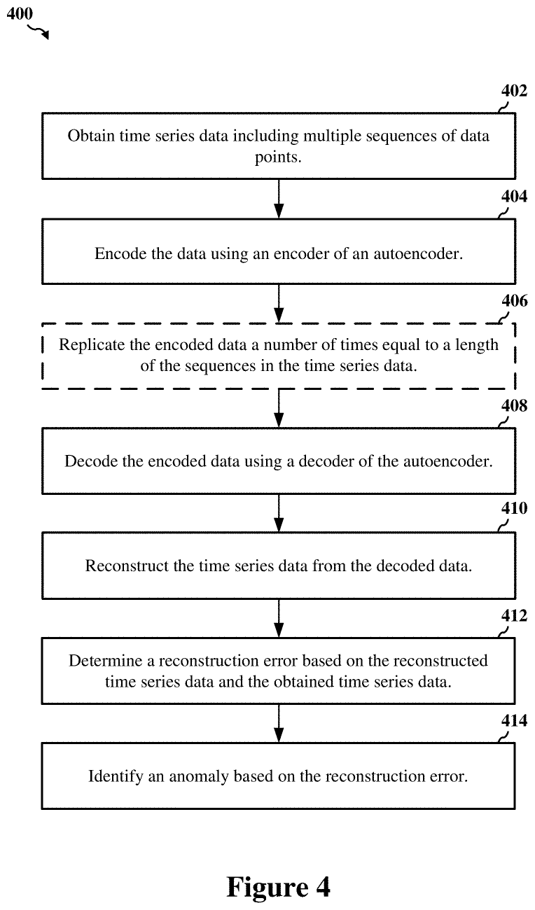

As used herein, an anomaly may be defined as a change in the input data from expected based on historical patterns. For example, sudden changes in payments, invoices, or revenue above a tolerance from historical patterns may be considered an anomaly. An anomaly may be further defined as changes to the input data that cause a change in output above a tolerance (such as changes in the input data that affect business revenue greater than a threshold amount). In some implementations, an anomaly in the input data is identified based on a difference between the actual input data and the expected input data across the multiple sequences of the time series data. Specific examples of identifying anomalies are described below with reference to FIG. 3 and FIG. 4.

Time series data may also include historical data used to train the system 100 (such as the autoencoder 140, the prediction model 150, and/or the feature identifier 160). For example, two years of business data for different features may be obtained via the interface 110 to train the system 100. The output data may include an indication of an anomaly identified by the system 100 (such as a visual or audible indication via a display, speakers, and so on to the user of an anomaly identified using the autoencoder 140), predicted data by the system 100 (such as a future data point in the time series data predicted by the system 100 using the prediction model 150), or one or more features identified as contributing to the output (such as the top features contributing to an anomaly and the amount of contribution as identified using the feature identifier 160).

The database 120 can store any suitable information relating to the time series data, predicted data, identified anomalies, identified features, or other suitable data. For example, the database 120 can store each sequence for a feature in the time series data, a record of the anomalies, the features contributing to the anomalies, and data points predicted from the time series data. In some instances, the database 120 can be a relational database capable of manipulating any number of various data sets using relational operators, and present one or more data sets and/or manipulations of the data sets to a user in tabular form. The database 120 can also use Structured Query Language (SQL) for querying and maintaining the database, and/or can store information relevant to the features in tabular form, either collectively in a feature table or individually for each feature.

The one or more processors 130, which may be used for general data processing operations (such as transforming data stored in the database 120 into usable information), may be one or more suitable processors capable of executing scripts or instructions of one or more software programs stored in the system 100 (such as within the memory 135). The one or more processors 130 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the one or more processors 130 may be implemented as a combination of computing devices (such as a combination of a DSP and a microprocessor, a plurality of microprocessors, one or more microprocessors in conjunction with a DSP core, or any other such configuration).

The memory 135 may be any suitable persistent memory (such as one or more nonvolatile memory elements, such as EPROM, EEPROM, Flash memory, a hard drive, etc.) that can store any number of software programs, executable instructions, machine code, algorithms, and the like that, when executed by the one or more processors 130, causes the system 100 to perform at least some of the operations described below with reference to one or more of the Figures. In some instances, the memory 135 can also store training data, seed data, and/or test data for the components 140-160.

The autoencoder 140 can be used to identify one or more anomalies in time series data obtained by the system 100. In some implementations, the autoencoder 140 is configured to allow for additional decoders to receive the encoded data for additional operations (such as for prediction modeling 150). The autoencoder 140 may also be configured to format the encoded data for use by the feature identifier to identify features and their contributions to anomalous outputs or to non-anomalous outputs. While the system 100 and the examples herein describe use of an autoencoder, in some other implementations, operations described herein may be performed by other suitable recurrent neural networks.

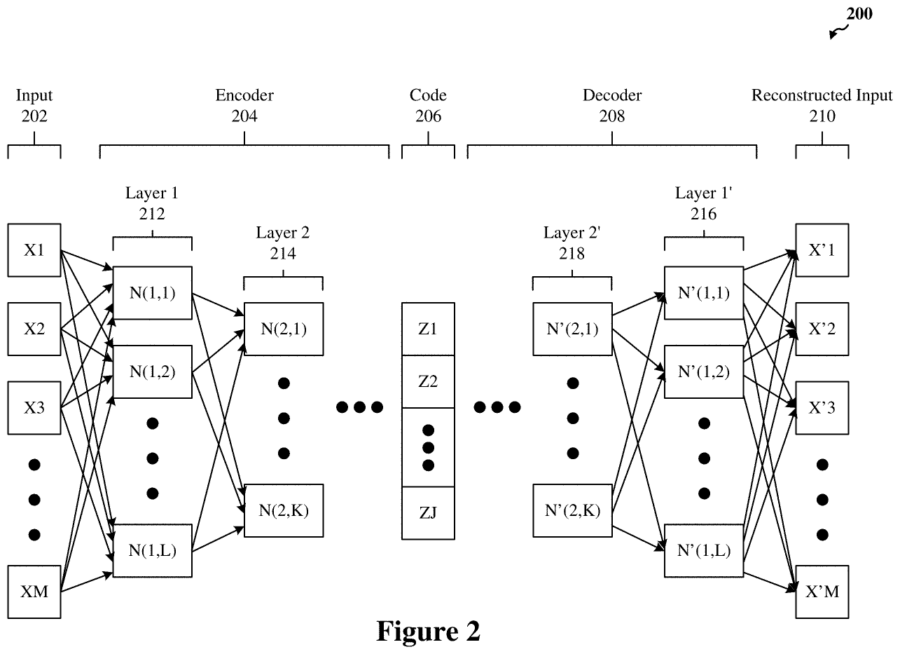

The autoencoder 140 is configured to preserve relationships between data points in a sequence. In some implementations, the autoencoder 140 includes layers of long short term memory (LSTM) units. In some other implementations, the autoencoder 140 may include layers of gated recurrent units (GRUs) or a combination of LSTM units (also referred to as LSTMs) and GRUs. Example implementations of the autoencoder 140 are described below with reference to FIGS. 2 and 3.

The prediction model 150 can be used to predict one or more data points from the time series data obtained by the system 100. In some implementations, the prediction model 150 includes a decoder to obtain an instance of the encoded data (also referred to as the code) from the encoder of the autoencoder 140, decode the encoded data, and predict one or more new data points. The decoder of the prediction model 150 may include layers of LSTMs, GRUs, or a combination of LSTMs and GRUs. Since the prediction model 150 may receive the code from the autoencoder 140, the autoencoder 140 and the prediction model 150 may be configured to be trained concurrently to reduce any possible conflicts between the predictions from the prediction model 150 and the anomalies detected by the autoencoder 140. While the prediction model 150 is described herein as a second decoder to receive code from the autoencoder 140, the prediction model 150 can include one or more other suitable machine learning models based on one or more of decision trees, random forests, logistic regression, nearest neighbors, classification trees, control flow graphs, support vector machines, naïve Bayes, Bayesian Networks, value sets, hidden Markov models, or neural networks configured to predict one or more data points from the encoded data.

The feature identifier 160 can be used to identify one or more features contributing to an output and a feature's contribution to the output (such as a feature's contribution to an anomaly). In some implementations, the feature identifier 160 is configured to generate a SHAP value for one or more features in the time series data. The SHAP value provides a quantitative representative of the contribution of the associated feature to an output determined by the autoencoder 140. For example, a large positive SHAP value may indicate that the feature plays a relatively large role in the output being anomalous, while a large negative SHAP score may indicate that the feature plays a relatively large role in preventing the output from being anomalous. The feature-level SHAP values determined by the feature identifier 160 are used to explain the relationships between features and the output. In this manner, a user may be apprised of features contributing to anomalous data and the features' contribution to the anomaly. The SHAP values may also indicate the features most impactful on predicted data points by the prediction model 150. With the user aware of the features impacting anomalies and predictions, the user may tailor business operations to adjust the outputs as desired (such as to maintain revenue or increase liquidity).

Each of the autoencoder 140, the prediction model 150, and the feature identifier 160 may be incorporated in software (such as software stored in memory 135) and executed by one or more processors (such as the one or more processors 130), may be incorporated in hardware (such as one or more application specific integrated circuits (ASICs), or may be incorporated in a combination of hardware or software. In addition or to the alternative, one or more of the components 140-160 may be combined into a single component or may be split into additional components not shown. The particular architecture of the system 100 shown in FIG. 1 is but one example of a variety of different architectures within which aspects of the present disclosure may be implemented.

FIG. 2 shows a block diagram of an example autoencoder 200. The autoencoder 200 is a generalized diagram of the autoencoder 140 in FIG. 1. The autoencoder 200 includes an encoder 204 and a decoder 208. The encoder 204 receives the input 202 and generates the code 206. The input 202 may include time series data that includes multiple sequences X1 through XM (with M being an integer greater than one). Each sequence may be associated with a specific metric measured. For example, one sequence may include measurements of invoice payments, tax liabilities, product supply, and so on. The measurements may be at any interval, such as daily, weekly, monthly, and so on. If the measurements are monthly, then each new month is associated with a new data point for the sequence. In the example, the number of sequences for the system may be M. The encoder 204 includes multiple layers of recurrent units (such as LSTMs or GRUs). In the example, the encoder 204 may include a layer 1 212 of LSTMs N(x,y). Integer x equal to one indicates the first layer of the encoder 204, and integer y from 1 to L indicates the specific LSTM of the layer (with integer L being less than or equal to M). The encoder 204 may also includer a layer 2 214 of LSTMs N(x,y). Integer x equal to two indicates the second layer of the encoder 204, and integer y from 1 to K indicates the specific LSTM of the layer (with integer K being less than or equal to L). The output of the last layer of the encoder 204 is code 206. Code 206 (including arrays Z1 through ZJ) includes a compressed lower dimensional representation of the input 202 (with integer J less than or equal to integer M). For example, Z1 through ZJ may be a two dimensional array representing a three dimensional input 202.

In some implementations, the encoder 204 includes 256 layers of LSTMs. However, any suitable number of layers may be used. As is the case for recurrent neural networks, each LSTM includes a loop to provide a previous output of the LSTM as an input to that LSTM for generating the next output. In this manner, the history of previous outputs may influence current outputs of the LSTM. An LSTM may be configured to output a defined number of points in a sequence for an input. In an example implementation of the encoder 204, an LSTM is configured to output a sequence of 25 points. If an LSTM of a current layer is to receive outputs from multiple LSTMs from a previous layer, the previous outputs may be combined in any suitable manner (such as determined during training of the encoder 204). In this manner, the encoder 204 of the autoencoder 200 is configured to receive three dimensional data (two dimensional samples of output per time for one dimension of the number of features). Each sample includes a multivariate time series of a defined length. The encoder 204 outputs two dimensional data (such as code 206).

The decoder 208 of the autoencoder 200 is configured to reconstruct the input 202 (referred to as reconstructed input 210) from the code 206. The decoder 208 may include one or more layers of LSTMs (such as layer 1′ 216 and layer 2′ 218). In an example implementation of the autoencoder 200, the decoder 208 includes 256 layers of LSTMs. Similar to the encoder 204, the decoder 208 may be configured to receive three dimensional data. However, the decoder 208 is to reconstruct the input data from the code 206 (which is two dimensional). The autoencoder 200 may be configured to generate three dimensional data from a two dimensional code 206. For example, the autoencoder 200 may replicate the two dimensional code 206 a number of times to generate three dimensional data (with the additional dimension representing the number of replications of the two dimensional data). In this manner, the decoder 208 may receive three dimensional data as an input. The decoder 208 may output the reconstructed data as a combination of all of the reconstructed sequences. For example, if the input data 202 includes four time sequences, the decoder 208 may be configured to output a combination of four time sequences reconstructed from the code 206. The autoencoder 200 may be configured to shape the data from the decoder 208 into a three dimensional output of reconstructed input 210. For example, a time distributed operation may be performed on the output of the decoder 208 to split the samples into time sequences of a defined length (with the length of the sequences' output equaling the length of the sequences' input). To determine if an anomaly exists in the data, the output 210 may be compared to the input 202 to detect variations between the actual inputs 202 and the predicted inputs 210. An example implementation and operation of the autoencoder 200 is described in more detail below with reference to FIGS. 3 and 4.

FIG. 3 shows a block diagram 300 of an example autoencoder 301. The autoencoder 301 may be an example implementation of the autoencoder 200 in FIG. 2. In some implementations, the autoencoder 301 is implemented using one or more Python libraries (such as the Keras application programming interface (API) for Python). In this manner, one or more processors perform the described operations by executing the library operations for the autoencoder 301. The examples herein describing an operation of receiving, obtaining, outputting, generating, or otherwise manipulating data may refer to the one or processors performing the data manipulation when executing the software. While the Keras API is described in the below examples, any suitable libraries for artificial neural networks may be used in performing the described operations. In addition, or to the alternative, hardware or a combination of hardware and software may be used in implementing the autoencoder 301. FIG. 4 shows an illustrative flowchart 400 depicting an example operation for identifying anomalies using an autoencoder, according to some implementations. The autoencoder 301 is described below with reference to the example operation 400 in FIG. 4.

At 402, the autoencoder 301 obtains the time series data 302. The time series data 302 is an example implementation of the input 202 in FIG. 2. In this manner, the time series data 302 includes multiple sequences of data points for a plurality of features. Each data point of a sequence corresponds to another data point in the other sequences based on time. For example, the corresponding data points may be sampled at a common time or over a common time period. While not shown in FIG. 4, the autoencoder 301 may shape the data input to the autoencoder 301. In some implementations, obtaining the time series data 302 includes an LSTM input operation of the Keras API, which is configured to shape the data as desired by the user. For example, the “obtain data” block 304 includes an “LSTM Input” operation of the Keras API configured to receive and shape the time series data 302 into shaped data 306. Shaped data 306 is to be provided to the encoder of the autoencoder 301 for generating the encoded data (code).

At 404, the autoencoder 301 encodes the data using an encoder of the autoencoder 301. In some implementations, encoding the data includes an “LSTM” operation of the Keras API. For example, the LSTM Operation 308 includes an “LSTM” operation of the Keras API configured to encode the shaped data 306 into encoded data 310. The LSTM Operation 308 outputs two dimensional data from the three dimensional data input. In this manner, the encoded data 310 is a lower dimensional, compressed representation of the time series data 302. In a simplified example, if four sequences exist and the LSTM Operation 308 outputs data points for sequences of length 25, the LSTM Operation 308 outputs 100 data points for each sample.

At 408, the autoencoder 301 decodes the encoded data using a decoder of the autoencoder 301. In some implementations, decoding the data includes an “LSTM” operation of the Keras API (such as the operation described with reference to step 404 and block 308). For example, the LSTM Operation 316 includes an “LSTM” operation of the Keras API configured to decode the encoded data into reconstructed data. As noted above, the output of the LSTM Operation 308 may be two dimensional data, and the LSTM Operation 316 is configured to receive three dimensional data. In some implementations, the autoencoder 301 is configured to replicate the encoded data 310 (406). The number of times the encoded data 310 is replicated may be equal to a length of the sequences in the time series data 301. For example, if the length of the sequences in the time series data 301 is 25 data points, the encoded data 310 may be replicated 25 times. The replicated data may be exact duplicates or may be similar but not exact to the original encoded data 310. An example replication of the encoded data 310 includes a “RepeatVector” operation in the Keras API. For example, the RepeatVector Operation 312 includes the “RepeatVector” operation of the Keras API configured to repeat the encoded data 310 to generate repeated, encoded data 314. The LSTM Operation 316 may generate reconstructed, shaped data 318 from the repeated, encoded data 314. In this manner, the output of the decoder may include a number of data points equal to the number of data points in the time series data 302.

At 410, the autoencoder 301 reconstructs the time series data from the decoded data. For example, the autoencoder 301 generates reconstructed time series data 322 from the reconstructed, shaped data 318. As noted above, the “LSTM” operation may output two dimensional data. As a result, the autoencoder 301 may reconstruct three dimensional data from the two dimensional data. In some implementations, reconstructing the time series data includes a “TimeDistributed” operation in the Keras API. For example, the TimeDistributed Operation 320 includes the “TimeDistributed” operation of the Keras API configured to convert the reconstructed, shaped data 318 (including a total number of data points not in sequences) into the reconstructed time series data 322 by splitting the total number of data points into sequences with the same length and the same number of sequences as the input time series data 302. In this manner, a one-to-one comparison may be performed between corresponding sequences of the reconstructed data 322 and the input data 302.

At 412, a reconstruction error is determined by the Error Operation 324 based on the reconstructed time series data 322 and the obtained time series data 302. In some implementations, the autoencoder 301 is configured to include an additional layer for determining the reconstruction error (such as including the Error Operation 324). In some other implementations, the Error Operation 324 is implemented outside of the autoencoder 301 and configured to receive the reconstructed time series data 322 output by the autoencoder 301 and to receive the time series data 302 input to the autoencoder 301. The Error Operation 324 generates the reconstruction error 326. The reconstruction error 326 may be a combination of one or more reconstruction errors associated with each pair of corresponding sequences between the input time series data 302 and the output time series data 322. In some implementations, the reconstruction error 326 is a total reconstruction error combining the errors determined for each pair of corresponding sequences.

For example, each pair of corresponding sequences includes pairs of corresponding data points (such as based on a common time or time period for sampling of the data points). For example, an input time sequence may measure supply monthly, and a reconstructed time sequence attempts to reconstruct the input time sequence. In this manner, each monthly data point in the input time sequence is associated with a data point in the reconstructed time sequence. A reconstruction error for the pair of corresponding sequences may include a mean squared error (MSE) determined from the pairs of corresponding data points. In this manner, a number of MSEs equal to the number of pairs of corresponding sequences may be determined. In some implementations, the MSEs are summed to generate the total reconstruction error. If the data points' values between different pairs do not include similar ranges for comparison across pairs, the MSEs (or the underlying data point values to generate the MSEs) may be normalized to a common range before summing the MSEs to generate the total reconstruction error 326.

At 414, an anomaly may be identified based on the reconstruction error. In some implementations, the autoencoder 301 may compare the total reconstruction error 326 to a defined threshold. The threshold may correspond to a tolerance in the data for detecting anomalies. An anomaly is detected if the total reconstruction error 326 is greater than the threshold (which may indicate that the MSEs in total are greater than the tolerance). Step 414 of determining the anomaly may be implemented in the autoencoder 140 in FIG. 1, the feature identifier 160 in FIG. 1, or any other suitable component of a system configured to detect anomalies from the input data. The system 100 may indicate to the user (such as via the interface 110) a detected anomaly in the time series data.

Referring back to FIG. 2, training the autoencoder 200 (including training the encoder 204 and the decoder 208) may include inputting historical data (such as two years of previous business data measured monthly) as training data into the autoencoder 200 a number of epochs until weights (such as weights corresponding to the arrows in the encoder 204 and the decoder 208 or to recursions in the LSTMs of the encoder 204 and the decoder 208) stabilize to desired values. The autoencoder 200 may thus be trained by recursively inputting the training data, determining the total reconstruction error, and adjusting one or more weights a number of times to attempt to reduce the total reconstruction error until the total reconstruction error (referred to as a training loss during training) is below a threshold. For example, the Adam optimization algorithm may be used to stop training if the training loss does not reduce by a threshold amount defined by the algorithm over a consecutive number of epochs (which may be defined by the algorithm or manually) of applying the training data to the autoencoder 200. After training is stopped, the autoencoder 200 is trained to determine a reconstruction error from new time series data and to detect anomalies based on the reconstruction error.

Referring back to FIG. 1, in addition to identifying anomalies, the system 100 may be configured to predict one or more points of time series data. For example, if a user is interested in a business' future cash flow, the prediction model 150 may be configured to predict cash flow of the business at one or more future points in time. Predicting one or more data points may be performed using a second decoder coupled to the autoencoder 140. In some implementations, the autoencoder 140 is configured to allow for multiple decoders. For example, referring to FIG. 2, the decoder 208 is configured to receive one instance of the code 206 and construct time series data from the code 206 for anomaly detection. The prediction model 150 may include another decoder configured to receive another instance of the code 206 and predict one or more data points of time series data. For example, the prediction model 150 may attempt to construct time series data from the code 206 including one or more future data points. In some implementations, the prediction model 150 includes one or more LSTM layers (similar to the decoder 208 in FIG. 2) used to generate predicted data points of the sequences or a predicted data point based on the sequences in the time series data.

Since the decoder of the prediction model 150 may be similar to the decoder of the autoencoder 140 (such as including layers of LSTMs to construct time series data), and both decoders decode the code from the encoder of the autoencoder, the decoder of the prediction model 150 may be trained concurrently with and similar to training the autoencoder. In this manner, training data may be received and processed by the encoder of the autoencoder 140 to generate the code (with the decoder of the prediction model 150 decoding the code to generate reconstructed data), weights may be adjusted for the decoder of the prediction model 150 based on a comparison of the original data and reconstructed data, and the process may be repeated until the a training loss associated with the decoder of the prediction model is less than a threshold or is not reduced by a threshold amount over a consecutive number of epochs in processing the training data. Since the prediction model also predicts one or more data points, the accuracy of the predicted data points may be determined and used to train the prediction model 150. For example, an MSE may be determined for a sequence of predicted data points for a desired output (such as business cash flow or revenue), and the prediction model 150 is trained to reduce the MSE (also in light of reducing the total reconstruction error during training of the autoencoder 140). After the prediction model 150 is trained, the prediction model 150 is configured to obtain encoded data determined by the autoencoder 140 and predict one or more data points for the obtained time series data of the autoencoder 140 from the encoded data.

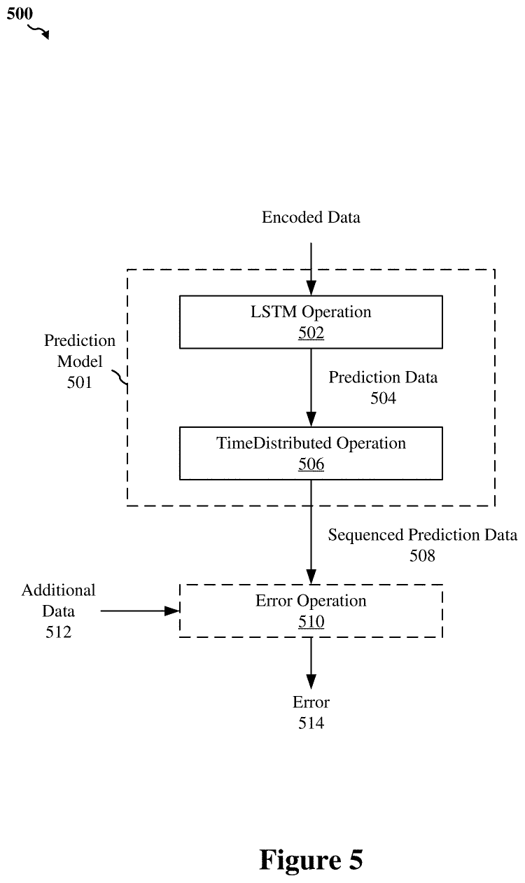

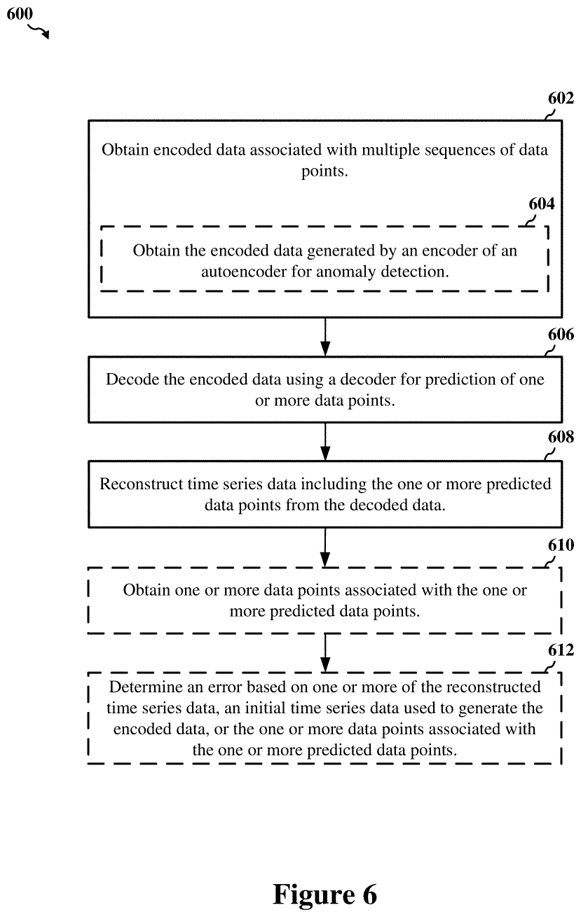

Example operations of the prediction model 150 are described below with reference to FIG. 5 and FIG. 6. FIG. 5 shows a block diagram 500 of an example prediction model 501 for predicting output data points, according to some implementations. The prediction model 501 is an example implementation of the prediction model 150 in FIG. 1. In some implementations, the prediction model 501 is implemented using one or more Python libraries (such as the Keras API for Python). In this manner, one or more processors perform the described operations by executing the library operations for the prediction model 501. The examples herein describing an operation receiving, obtaining, outputting, generating, or otherwise manipulating data may refer to the one or processors performing the data manipulation when executing the software. While the Keras API is described in the below examples, any suitable libraries for artificial neural networks may be used in performing the described operations. In addition or to the alternative, hardware or a combination of hardware and software may be used in implementing the prediction model 501. FIG. 6 shows an illustrative flowchart depicting an example operation 600 for predicting output data points using a prediction model, according to some implementations. The prediction model 501 is described below with reference to the example operation 600 in FIG. 6.

At 602, the prediction model 501 obtains encoded data associated with multiple sequences of data points (such as the code 206 being associated with the input data 202 of multiple time sequences in FIG. 2). In some implementations, the prediction model 501 obtains the encoded data generated by an encoder of an autoencoder for anomaly detection (604). For example, the prediction model 501 can obtain the code 206 in FIG. 2 or the encoded data 310 in FIG. 3. If the decoder of the prediction model 501 includes one or more layers of LSTMs, the decoder is configured to receive three dimensional data, and the encoded data may be two dimensional. For example, as described above, the encoded data 310 may be two dimensional. In some implementations, the prediction model 501 is configured to shape the obtained encoded data into three dimensional data (such as by replicating the encoded data or performing a “RepeatVector” operation, as described above). In some other implementations, obtaining the encoded data by the prediction model 501 includes obtaining an instance of the repeated, encoded data 314 from the autoencoder 301. In this manner, the prediction model 501 obtains three dimensional data that may be input into the decoder including one or more LSTM layers.

At 606, the prediction model 501 decodes the encoded data using a decoder for prediction of one or more data points. In some implementations, decoding the data includes an “LSTM” operation of the Keras API (such as described above). For example, the LSTM Operation 502 includes an “LSTM” operation of the Keras API configured to decode the encoded data into prediction data 504. The prediction data 504 may include data to generate reconstructed time series data and/or one or more predicted data points. However, the LSTM Operation 502 generates two dimensional data, and the data is to be shaped into sequences, such as described above with reference to the autoencoder 301. At 608, the prediction model 501 reconstructs time series data including one or more predicted data points from the decoded data. For example, a TimeDistributed Operation 506 shapes the two dimensional, prediction data 504 into three dimensional, sequenced prediction data 508. The TimeDistributed Operation 506 may be similar to the TimeDistributed Operation 320 in FIG. 3. While decoding the encoded data is described as being performed by an LSTM operation, any suitable recurrent neural network or other machine learning model may be used in predicting one or more data points from the encoded data. For example, the “predict” function in the Keras API may be executed to predict the next time series data points to occur (such as revenue or cash flow for the upcoming month).

The reconstructed time series data from the prediction model 501 includes the one or more predicted data points of interest to the user. In some implementations, the system 100 in FIG. 1 is configured to indicate the one or more predicted data points to the user (such as via the interface 110). Indicating the data points to the user may include displaying a graph or chart of the predicted data points.

The system 100 may also be configured to determine an accuracy of the predicted data points. For example, an error between the predicted data points and additional, actual data points obtained that correspond to the predicted data points may be determined, and the error indicates the accuracy of the prediction model 150. Referring back to FIG. 6, in some implementations, one or more data points (referred to as additional data 512) associated with the one or more predicted data points may be obtained (610). For example, if the one or more predicted data points include predictions of business revenue for the next two fiscal quarters, the system 100 may obtain measurements of the business revenue when the next fiscal quarters end. An error may be determined based on one or more of the reconstructed time series data from the prediction model 501, the initial time series data used to generate the encoded data obtained by the prediction model 501, or the additional data 512 (612). For example, an Error Operation 510 may compare the sequenced prediction data 508 (including the one or more predicted data points) and the additional data 512 to determine an error 514. Determining the error 514 may be as described above with reference to determining a reconstruction error between a pair of corresponding sequences or a total reconstruction across multiple pairs of sequences. In some implementations, the Error Operation 510 determines an MSE between a sequence of predicted data points from the sequenced prediction data 508 and a corresponding sequence of the additional data 512. The MSE indicates the accuracy of the prediction model 501, which may be used during training of the prediction model 501 (such as based on the Adam function for optimization based on reducing the MSE) or may be indicated to the user (such as via interface 110) to indicate the accuracy of the prediction model 501. In generating and optimizing the prediction model 501, the compile function in the Keras API may be used to compile the prediction model 501 (or one or more portions of the autoencoder).

Referring back to FIG. 1, the system 100 is configured to identify anomalies and predict data points from time series data. As noted above, an identified anomaly indicates an identified change in historical patterns of the time series data. The system 100 may also be configured to determine the contribution of one or more features to the anomaly. For example, an anomaly that affects business revenue may be identified using the autoencoder 140, and the system 100 indicates the identified anomaly to a user. The user may be interested in which features most contributed to the anomaly (or conversely, which features contribute to preventing time series data from being anomalous) to understand what causes changes in a desired output (such as business revenue or cash flow). The feature identifier 160 is configured to identify a feature and its contribution to the anomalous data or the non-anomalous data.

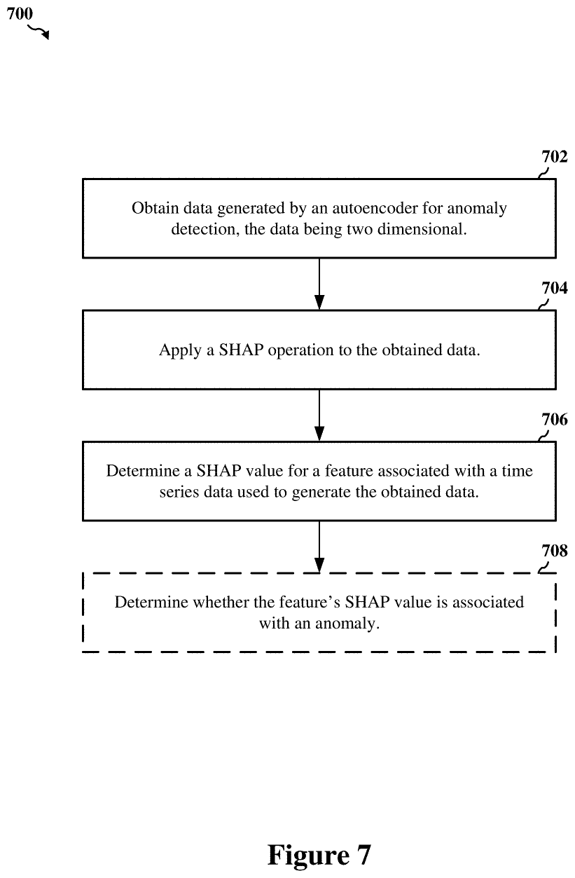

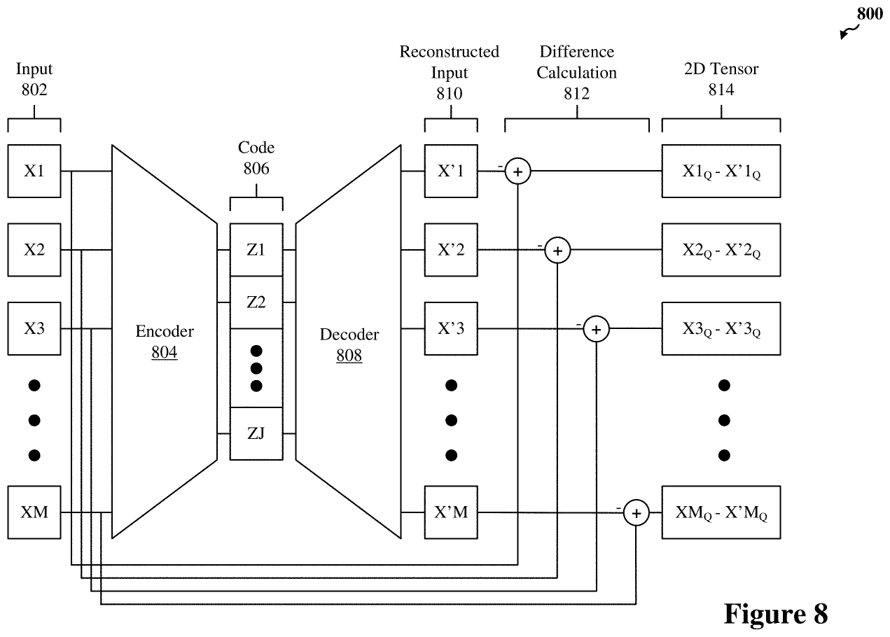

In some implementations, the feature identifier 160 determines one or more SHAP values from data generated by the autoencoder 140. Each SHAP value is for a feature of the time series data. Determining a SHAP value is an additive feature attribution method based on local game theory to determine a singular input's effect on an output from multiple inputs. For example, a SHAP value may indicate one sequence's effect from the time series data on causing an anomaly or preventing an anomaly. The model and operations to determine a SHAP value may be included in one or more Python libraries or other suitable software to be executed by one or more processors (such as the one or more processors 130 executing software stored in memory 135). For example, the SHAP package in Python may be used to determine SHAP values. In this manner, examples describing herein the feature identifier 160 or other components performing operations may refer to one or more processors (executing the software) performing the operations described. While the SHAP package in Python is used in describing operations in determining a SHAP value, any suitable software, hardware, or combination of hardware and software may be used in determining a SHAP value. Determining a feature's SHAP value is described below with reference to the example operation 700 in FIG. 7, and explaining a feature's SHAP value to a user is described with reference to the example indication 800 in FIG. 8.

FIG. 7 shows an illustrative flowchart depicting an example operation 700 for determining a SHAP value for a feature, according to some implementations. At 702, the feature identifier 160 (FIG. 1) obtains data generated by the autoencoder 140 used to detect anomalies. In some implementations, the feature identifier is configured to determine SHAP values based on the last set of inputs to the autoencoder 140. For example, for two years of input data measured monthly (with each sequence including 24 data points), the information associated with the last data point of each sequence (corresponding to the last month of the two years of data) from the autoencoder 140 is used in determining the SHAP values for the various features. In this manner, determined SHAP values indicate variations in the sequences in the last month that may be of importance to a user.

FIG. 8 shows a block diagram of an autoencoder 800 for interfacing with a feature identifier to generate SHAP values, according to some implementations. The autoencoder 800 may be similar to autoencoder 200 in FIG. 2, such as an encoder 804 to receive the input 802 of multiple time series and generate code 806 and a decoder 808 to receive the code 806 and generate the reconstructed input 810. The autoencoder 800 also includes an additional layer for calculating the error rate of the last data point for each time sequence (with the layer referred to as difference calculation 812 in FIG. 8). The output of the layer 812 may be the two dimensional tensor 814 that is provided to the feature identifier 160 for generating the SHAP values. The SHAP values are based on differences between the input 802 and the reconstructed input 810, but the model in the SHAP Python package may be configured to process two dimensional data. In this manner, the data that is obtained by the feature identifier 160 from the autoencoder 140 (the tensor 814) is two dimensional in order to generate SHAP values for the features associated with the input 802.

As shown in FIG. 8, each value of the tensor 814 may be a difference between the last data point of each reconstructed input 810 and the last data point of each input 802. For example, for time series data of data point 1 to data point Q (such as X1₁ to X1_{Q} for the first time series), the value in the tensor 814 may be (X1_{Q}-X′1_{Q}). While one example of a difference between corresponding data points between the input and the reconstructed input is provided, any suitable indication of a difference between the input data point and the reconstructed data point may be used. Referring back to FIG. 3, the error operation 324 may include the additional layer 812 for generating two dimensional data for the feature identifier 160 to generate SHAP values, and the reconstruction error 326 may include the two dimensional tensor 814. However, any suitable implementation of the layer 812 may be implemented for the autoencoder 140.

In some other implementations, the user may be interested in SHAP values associated with prior months (not just the last month for the input time series data). Therefore, the input data and the reconstructed data for prior months may also be of interest. In this manner, more than just the last data points of the input 802 and the reconstructed input 810 may be used in generating SHAP values. However, as noted above, a SHAP Python package may be configured to receive two dimensional data to generate SHAP values. In some implementations, the autoencoder 140 includes an additional layer to flatten three dimensional data into two dimensional data. For example, referring back to FIG. 8, the autoencoder 800 includes the additional layer 812 to generate the tensor 814. The layer generating a new tensor 814 for each additional data point of the sequences causes the autoencoder 800 to generate a sequence of two dimensional tensors 814 over time (which is three dimensional data). The three dimensional data may be flattened to two dimensional data before being provided to the feature identifier 160. In some implementations, the flatten function in the Keras API may be used to flatten the three dimensional matrix. The flatten function may also be used to flatten at the tensor level, too. In this manner, the implementation of the flatten function may act as an extra layer in or attached to the autoencoder to process three dimensional data (such as the tensors from previous layers in the autoencoder) into two dimensional data. The input to the feature identifier 160 is thus two dimensional data representing multiple months of differences between the input to the autoencoder 140 and the reconstructed input from the autoencoder 140.

In some other implementations, the feature identifier 160 may also obtain data from the LSTMs of the decoder of the autoencoder 140. Each LSTM in the one or more layers of the decoder of the autoencoder 140 generates tensors, and the tensor is based on a relationship between the inputs to the LSTM. The tensors are two dimensional (with one dimension being time). The amalgamation of the tensors is three dimensional data, which may be flattened using the Keras API or any other suitable means. For example, the overall reconstructed input 810 may be data represented in more than two dimensions. Data from along one dimension may be concatenated or otherwise combined to remove the dimension. In this manner, the data may be flattened to two dimensions. With the data flattened to two dimensions, the SHAP operation is applied to the flattened data to generate SHAP values for the features. In some implementations, the data may be unflattened before being provided to another system.

Referring back to FIG. 7, at 704, the feature identifier 160 applies a SHAP operation to the obtained, two-dimensional data. In some implementations, a SHAP operation from the SHAP package is applied to the tensor. At 706, the feature identifier 160 determines a SHAP value for a feature associated with a time series data used to generate the obtained data. For example, the SHAP operation is used to generate a SHAP value for each of one or more features defined for the reconstructed data. Since the reconstructed data is based on sequences of data and the tensors change during the sequences of data, the SHAP operation may use the tensor changes during the sequences to determine the one or more SHAP values. In some implementations, the SHAP operation is used by the system 100 to determine at least one SHAP value for each feature. Obtaining the tensors and performing the SHAP operation using the tensors may be based on a model developed using the TensorFlow library for Python or any other suitable model.

The determined SHAP values may be based on data for which an anomaly is detected by the autoencoder 140. Conversely, the determined SHAP values may be based on data for which an anomaly is not detected by the autoencoder 140. In this manner, some of the determined SHAP values for a feature may be associated with anomalous data, and other determined SHAP values for the feature may be associated with non-anomalous data. In some implementations, the feature identifier 160 is configured to determine a first SHAP value and a second SHAP value for a feature. The first SHAP value is associated with anomalous data, and the second SHAP value is associated with non-anomalous data.

Referring back to FIG. 7, if the feature identifier 160 is to determine a SHAP value associated with anomalous data, the feature identifier 160 determines whether the feature's SHAP value (determined in step 706) is associated with an anomaly (708). For example, the feature identifier 160 determines if the autoencoder 140 identifies an anomaly based on the time series data used to generate the data obtained by the feature identifier 160 from the autoencoder 140. In this manner, the SHAP value determined by the feature identifier 160 may be identified as the feature's first SHAP value associated with anomalous data. Referring back to FIG. 8, the SHAP operation may be applied to the 2D tensor 814, which is generated from the last instance of input 802 (such as last month's measurements) and reconstructed input 810. If the reconstructed input 810 for last month's measurements is identified by the autoencoder as being anomalous (such as described above with reference to describing the autoencoder), each SHAP value determined from that 2D tensor 814 is associated with an anomaly. While not shown in FIG. 7, the feature identifier 160 may identify each SHAP value as being associated with an anomaly (which may be referred to as being associated with anomalous data) or not being associated with an anomaly (which may be referred to as being associated with non-anomalous data). The SHAP values (and whether identified with an anomaly) may be stored by the system 100 (such as in memory 135 or the database 120).

With SHAP values determined for the multiple features of the time series data, the SHAP values may be presented to the user to explain the outputs of the autoencoder 140 and the prediction model 150. Explaining the outputs to the user based on the SHAP values may be based on any suitable explainers, including DeepExplainer (using DeepLIFT and SHAP values), GradientExplainer, or KernelExplainer (using LIME and SHAP values), which all support TensorFlow and the Keras API. In some implementations, the system 100 sorts the SHAP values in order to show or highlight the features with the greatest impact on output. For example, if the prediction model 150 predicts business revenue, the system 100 may indicate the features with the highest SHAP values impacting business revenue for the current time series data provided to the system 100. In some implementations, the system 100 provides a force plot (such as defined in the TensorFlow library) to indicate the impact of each SHAP value. In addition, the system 100 may provide a plot summarizing multiple SHAP values for each feature across the time period for the time series data.

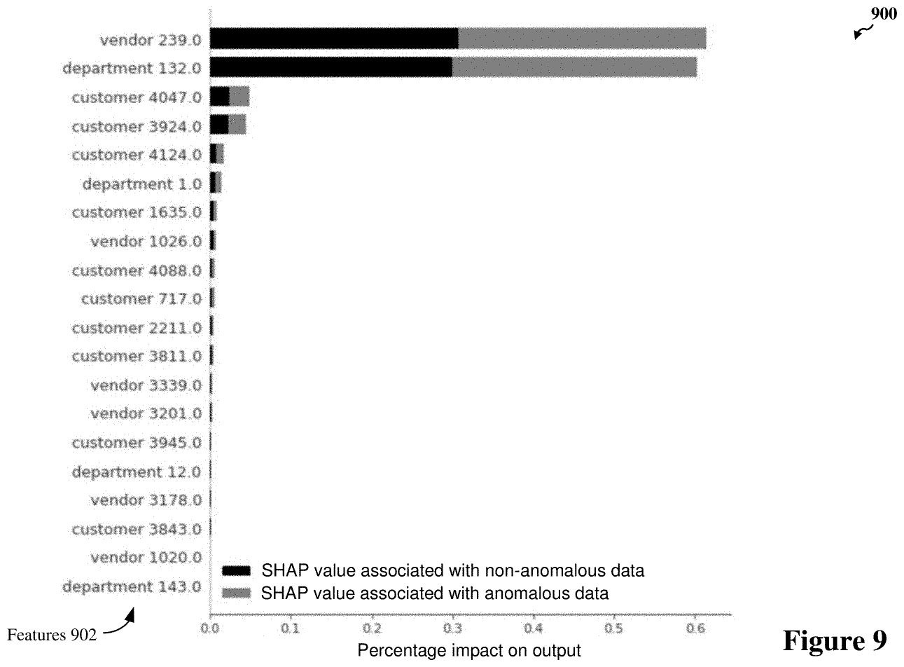

FIG. 9 shows a depiction of an example indication 900 of SHAP values for different features 902, according to some implementations. In the example, the system 100 may be configured to display the top 20 features 902 with the largest SHAP values. In this manner, the system 100 may arrange, organize, filter, or otherwise process the features' SHAP values in any suitable manner to explain to the user outputs of the system 100 (such as which features most contribute to an anomaly or predicted data points). As shown in FIG. 9, each feature 902 may be associated with two SHAP values (a first SHAP value associated with anomalous data (when an anomaly is detected) and a second SHAP value associated with non-anomalous data (when an anomaly is not detected)). For example, features “vendor 239” (indicating a specific vendor to the business) and “department 132” (indicating a specific business department) are the top contributors to variations between the outputs by the autoencoder 140 and the inputs. For example, the two features' first SHAP values indicate that the two features each contribute at least 30 percent to causing an anomaly, and the two features' second SHAP values indicate that the two features each contribute at least 30 percent to preventing an anomaly.

In FIG. 9, each of the first SHAP values and the second SHAP values are generated from multiple SHAP values for each feature across the time series data. For example, referring back to FIG. 8, the input 802 may be for two years of measurements captured every month. In this manner, X1-XM each include 24 data points at the end of the time period. The data points for the first month may be provided as input 802 to the encoder 804, a reconstructed input 810 may be generated, and a 2D tensor 814 may be generated. The SHAP operation may be applied to the 2D tensor 814 to generate SHAP values for the features for the first month of input data. If the reconstructed input 810 is associated with an anomaly, the SHAP values from the first month are identified as being associated with anomalous data. The SHAP values from the first month (and whether identified with an anomaly) are then stored. The next month, the second month of data points is provided as input 802, the reconstructed input 810 is generated, the 2D tensor 814 is generated, and SHAP values are generated for the features for the second month of input data. If the reconstructed input 810 for the second month is associated with an anomaly, the SHAP values from the second month are identified as being associated with anomalous data. The SHAP values from the second month (and whether identified with an anomaly) are then stored. The process may be repeated each month so that a plurality of monthly SHAP values exist for each feature. A first portion of the plurality of SHAP values is associated with anomalous data, and the remainder of the SHAP values is associated with non-anomalous data. For example, at the end of the two years, 24 SHAP values exist for each feature, x number of SHAP values are associated with anomalous data, and 24-x number of SHAP values are associated with non-anomalous data.

As noted above with reference to FIG. 9, a first SHAP value of a feature 902 is associated with anomalous data, and a second SHAP value of the feature 902 is associated with non-anomalous data. Referring back to the previous example of 24 SHAP values existing per feature, the first SHAP value of a feature 902 is a combination of the x number of SHAP values associated with anomalous data, and the second SHAP value of the feature 902 is a combination of the 24-x number of SHAP values associated with non-anomalous data. Each SHAP value in FIG. 9 is a mean (also referred to as an average) of the absolute values of the SHAP values. A mean of the absolute values (MAV) operation is defined in the Keras API using TensorFlow to provide the SHAP values in the example indication 900. For example, to determine a first SHAP value in FIG. 9 using the MAV operation, the absolute value is determined for each of the x number of SHAP values associated with anomalous data, and the absolute values are averaged. To determine a second SHAP value in FIG. 9 using the MAV operation, the absolute value is determined for each of the 24-x number of SHAP values associated with non-anomalous data, and the absolute values are averaged.

While the example above is described with reference to generating a first and second SHAP value after the time period (at the end of two years), the SHAP values in FIG. 9 may be generated at any point in time before or after two years (such as after 1 month of data, 6 months of data, one year of data, 32 months of data, and so on). For example, the example depiction 900 may be updated after each data point is provided to the autoencoder 140. In this manner, the system 100 is not required to wait until a specific point in time or after a specific time period of input data to the autoencoder 140 to generate SHAP values (such as based on a MAV of previously determined SHAP values for a feature). In some implementations, the system 100 is configured to store a defined number of SHAP values for each feature. For example, the system 100 may store 24 SHAP values for each feature, with the oldest SHAP value replaced by the newest SHAP value in a first in first out (FIFO) manner. In this manner, after 25 months, the feature identifier 160 may generate a 25th month SHAP value, and the first month SHAP value may be removed from storage to store the 25th month SHAP value. The first SHAP value and the second SHAP value (such as depicted in FIG. 9) then may be determined using the second month SHAP value to the 25th month SHAP value. In some other implementations, all SHAP values continue to be stored, but only a defined number of the most recent SHAP values are used to generate the first SHAP value and the second SHAP value for each feature.

In some implementations, the SHAP values are also used to indicate a contribution of a feature to an output of the prediction model 150. For example, if the prediction model 150 predicts business cash flow, the SHAP values may indicate the top two features as having the greatest impact on cash flow compared to the other features 902. While one example graph indicating the SHAP values is shown in FIG. 9, any suitable indication of SHAP values and explanation of the autoencoder 140 and the prediction model 150 to the user may be performed by the system 100.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method for identifying anomalies, comprising:
obtaining, by an autoencoder, time series data including multiple sequences of data points;
encoding, by an encoder of the autoencoder, the obtained time series data into encoded data;
decoding, by a decoder of the autoencoder, the encoded data into decoded data;
reconstructing time series data from the decoded data;
determining a reconstruction error based on the reconstructed time series data and the obtained time series data; and
identifying an anomaly based on the reconstruction error.

2. The method of claim 1, wherein:
encoding the obtained time series data includes generating the encoded data by one or more long short term memory (LSTM) layers of the encoder; and
decoding the encoded data includes generating the decoded data by one or more LSTM layers of the decoder.

3. The method of claim 2, further comprising replicating the encoded data before decoding, wherein a number of replications of the encoded data is based on a length of sequences in the obtained time series data.

4. The method of claim 2, wherein determining the reconstruction error includes:
for each pair of corresponding time sequences from the obtained time series data and the reconstructed time series data, determining a reconstruction error; and
combining the reconstruction errors to generate a total reconstruction error, wherein identifying an anomaly is based on the total reconstruction error.

5. The method of claim 4, wherein:
determining each reconstruction error includes determining a mean squared error (MSE) for each pair of corresponding time sequences; and
determining the total reconstruction error includes summing the reconstruction errors.

6. The method of claim 5, further comprising normalizing the reconstruction errors to a common range before combining the reconstruction errors to generate the total reconstruction error.

7. The method of claim 2, further comprising predicting one or more data points from the encoded data, wherein predicting the one or more data points includes:
obtaining the encoded data generated by the encoder of the autoencoder; and
decoding, by a decoder of a prediction model, the encoded data to generate prediction data including the one or more predicted data points.

8. The method of claim 7, further comprising replicating the encoded data before decoding by the decoder of the autoencoder, wherein:
a number of replications of the encoded data is based on a length of sequences in the obtained time series data; and
obtaining the encoded data includes obtaining the replicated, encoded data.

9. The method of claim 7, wherein decoding the encoded data by the decoder of the prediction model includes generating the prediction data by one or more LSTM layers of the prediction model.

10. The method of claim 1, further comprising:
generating a two dimensional tensor including differences between a last group of data points of the obtained time series data and a last group of corresponding data points of the reconstructed time series data; and
determining, from the two dimensional tensor, a Shapley additive explanation (SHAP) value for one or more features associated with an output of the autoencoder or a prediction model, wherein the obtained time series data is associated with a plurality of features.

11. The method of claim 10, further comprising indicating the SHAP value to a user in explaining the output of the autoencoder or the prediction model.

12. A system for identifying anomalies, comprising:
one or more processors; and
a memory coupled to the one or more processors and storing instructions that, when executed by the one or more processors, cause the system to perform operations comprising:
obtaining, by an autoencoder, time series data including multiple sequences of data points;
encoding, by an encoder of the autoencoder, the obtained time series data into encoded data;
decoding, by a decoder of the autoencoder, the encoded data into decoded data;
reconstructing time series data from the decoded data;
determining a reconstruction error based on the reconstructed time series data and the obtained time series data; and
identifying an anomaly based on the reconstruction error.

13. The system of claim 12, wherein:
encoding the obtained time series data includes generating the encoded data by one or more long short term memory (LSTM) layers of the encoder; and
decoding the encoded data includes generating the decoded data by one or more LSTM layers of the decoder.

14. The system of claim 13, wherein determining the reconstruction error includes:
for each pair of corresponding time sequences from the obtained time series data and the reconstructed time series data, determining a reconstruction error; and
combining the reconstruction errors to generate a total reconstruction error, wherein identifying an anomaly is based on the total reconstruction error.

15. The system of claim 13, wherein execution of the instructions causes the system to perform operations further comprising predicting one or more data points from the encoded data, wherein predicting the one or more data points includes:
obtaining, by a prediction model, the encoded data generated by the encoder of the autoencoder; and
decoding, by a decoder of the prediction model, the encoded data to generate prediction data including the one or more predicted data points.

16. The system of claim 15, wherein decoding the encoded data by the decoder of the prediction model includes generating the prediction data by one or more LSTM layers of the prediction model.

17. The system of claim 12, wherein execution of the instructions causes the system to perform operations further comprising:
generating a two dimensional tensor including differences between a last group of data points of the obtained time series data and a last group of corresponding data points of the reconstructed time series data; and
determining, from the two dimensional tensor, a Shapley additive explanation (SHAP) value for one or more features associated with an output of the autoencoder or the prediction model, wherein the obtained time series data is associated with a plurality of features.

18. A non-transitory, computer readable medium storing instructions that, when executed by one or more processors of a system for identifying anomalies, causes the system to perform operations comprising:
obtaining, by an autoencoder, time series data including multiple sequences of data points;
encoding, by an encoder of the autoencoder, the obtained time series data into encoded data;
decoding, by a decoder of the autoencoder, the encoded data into decoded data;
reconstructing time series data from the decoded data;
determining a reconstruction error based on the reconstructed time series data and the obtained time series data; and
identifying an anomaly based on the reconstruction error.

19. The computer readable medium of claim 18, wherein:
encoding the obtained time series data includes generating the encoded data by one or more long short term memory (LSTM) layers of the encoder;
decoding the encoded data includes generating the decoded data by one or more LSTM layers of the decoder; and
execution of the instructions causes the system to perform operations further comprising predicting one or more data points from the encoded data, wherein predicting the one or more data points includes:
obtaining the encoded data generated by the encoder of the autoencoder; and
decoding, by a decoder of a prediction model, the encoded data to generate prediction data including the one or more predicted data points.

20. The computer readable medium of claim 18, wherein execution of the instructions causes the system to perform operations further comprising:
generating a two dimensional tensor including differences between a last group of data points of the obtained time series data and a last group of corresponding data points of the reconstructed time series data; and
determining, from the two dimensional tensor, a Shapley additive explanation (SHAP) value for one or more features associated with an output of the autoencoder or a prediction model, wherein the obtained time series data is associated with a plurality of features.
